(19) United States
(12) Patent Application Publication
(10) Pub. No.: US 2011/0016870 A1
(43) Pub. Date: Jan. 27, 2011

(54) METHOD AND APPARATUS FOR IMPROVED GAS TURBINE EFFICIENCY AND AUGMENTED POWER OUTPUT

(76) Inventor: Yefim Kashler, Brooklyn, NY (US)

Correspondence Address: Yefim Kashler, 213 Bay 26 St, Brooklyn, NY, 11214, US

(21) Appl. No.: 12/508,137

(22) Filed: Jul. 23, 2009

(51) Int. Cl. F02C 7/224; F02C 6/00

(52) U.S. Cl. 60/772; 60/736; 290/52

(57) ABSTRACT

A method and apparatus for improved gas turbine efficiency and augmented power output employs a combustion turbine for electrical or mechanical power generation system in a simple or combined power generation cycle which contains air-to-fuel heat exchanger. The heat exchanger cools down portion of hot compressor discharge air utilized for cooling of hot gas turbine components, such as vanes and blades. Colder component cooling air allows for higher combustor firing temperatures thereby improving gas turbine efficiency and allowing for augmented power output. Simultaneously the heat exchanger pre-heats natural gas utilized for driving the gas turbine unit prior to entering a combustor of the gas turbine, which also allows for significant improvement of the cycle efficiency. Thus, both effects of the heat exchanger installation result in gas turbine efficiency improvements and lowering power generation cycle heat rate because of the lower energy requirements for pre-heating fuel in the combustor and allowing higher combustor temperatures due to the colder component cooling air.

### BACKGROUND OF THE INVENTION

1. Field of the Invention

The present invention relates to electric or mechanical power generation. More specifically, the present invention is a method and apparatus for improved gas turbine (also known as combustion turbine) efficiency and augmented power output of gas turbines, utilized in electric power generation or as a mechanical drive for various types of rotating machines, which use natural gas as primary fuel.

Most power gas turbines use compressed air for cooling of hot turbine components, such as turbine vanes, blades, etc. Usually this cooling air is the gas turbine compressor discharge air, which has sufficient pressure for component cooling, but also has high temperature due to the physics of the compression process. It is desirable to lower the temperature of this cooling air. This would provide better cooling of hot components of the gas turbine and allow for higher combustion process temperature and would contribute to higher unit efficiency as well as higher power output. In a typical configuration of a gas turbine natural gas is supplied at pipeline temperature. For higher unit efficiency it is desirable to pre-heat incoming to the combustor fuel gas, thereby minimizing heat consumption.

2. Description of the Related Art

In the generation of electrical or mechanical power, efficiency is desired to maximize the benefit extracted from a given amount of fuel or energy input into the power generation system. Efficiency may be gained by reducing the amount of energy lost in the electrical power generation process, recovering lost energy or improving key thermodynamic cycle parameters. In numerous electrical power generating systems the primary form of energy used to drive electrical generators, or the primary energy by-product, is heat. In a typical example, a gas turbine is used to drive an electrical generator. A fuel source is combusted to drive the gas turbine, and the combustion by-products (primarily hot combustion gasses) are discharged to a stack or a heat recovery steam generator. Lowering the amount of required energy or increasing gas turbine firing temperature both result in improved efficiency.

Most gas turbines consist of three main components: axial air compressor, combustor and power turbine, which drives the axial air compressor and provides access power to drive electric generator or another rotating machine.

Part of the thermal energy released during the combustion process in the combustor of the gas turbine is used to pre-heat natural gas (or other fuel) itself up to the fuel flash point before the chemical reaction of combustion (combining fuel molecules with oxygen) could occur. Lowering the amount of this energy would directly improve gas turbine unit efficiency. For this purpose some vendors offer external natural gas heaters, which primarily utilize steam or hot flue gas as heating media. This has only a limited effect on the power plant efficiency, because less steam would be available to generate power in the steam turbine of a combined cycle power plant.

Modern gas turbines operate at 1800-2500 deg. F. temperatures at the combustor outlet. A number of gas turbine components are exposed to this high temperature. Those components utilize various thermal barrier coatings and elaborate internal cooling air passages to protect metal of turbine components such as turbine vanes, blades, etc., from failure caused by exposure to high combustion temperatures. Most common source of this cooling air is the compressor discharge air, where certain percentage of compressor airflow is extracted from the discharge airflow and diverted to the component cooling system.

Since extraction of the cooling air reduces mass flow of the working fluid (air) through the gas turbine the power output of the gas turbine unit is proportionally reduced. Therefore it is beneficial to reduce the amount of cooling air. It is also beneficial to lower the temperature of this cooling air, as the air would have higher cooling potential. Colder cooling air also allows increasing combustion chamber firing temperature, which in turn improves gas turbine cycle efficiency.

Efficiency of a gas turbine cycle, commonly referred as a simple power generation cycle (or Brayton cycle) is generally higher with increased compression ratio, and higher combustion temperature. Same is true for a combined gas turbine cycle, which utilizes Rankine cycle, containing HRSG and a steam turbine in the bottoming steam cycle.

Modern gas turbines have compression ratios of 10 to 20. Higher compression ratio corresponds to higher efficiency. At such compression ratios compressor discharge air has the required pressure to cool the hot components; however, increasing the compression ratio in turn increases the compressor discharge air temperature, which reduces the cooling potential of the air. Air temperature corresponding to such compression ratios is in the 650-950 deg. F. range. At such high temperature in many cases the cooling air has to be cooled itself before entering the gas turbine component cooling system. Various external coolers, which utilize ambient air, water, etc., may be used for this purpose. Most of those external coolers directly contribute to the thermal cycle heat losses and lower the cycle efficiency.

For better component cooling it is desirable to lower the cooling air temperature, and for energy efficiency improvement it is desirable to capture the heat of this air and pre-heat incoming to the combustion chamber natural gas.

### SUMMARY OF THE INVENTION

To improve energy efficiency of gas turbine power generation plant the current invention employs a heat exchanger which pre-heats fuel gas utilized to drive the gas turbine and cools down compressed air utilized for cooling of gas turbine hot components, such as turbine vanes, blades, etc. This heat exchanger minimizes amount of heat necessary to preheat fuel in the gas turbine combustor before the combustion of fuel can take place and lowers temperature of the component cooling air, thereby improving gas turbine efficiency. This heat exchanger also improves cooling potential of the component cooling air by lowering its temperature. Better component cooling would allow increasing of the gas turbine combustion temperature, which in turn further improves gas turbine efficiency and allows for augmented power output. Installation of the heat exchanger between hot component cooling air and cold fuel gas accomplishes both tasks, allowing significant improvement of the cycle efficiency and lowering heat rate of both simple and combined gas turbine cycles.

This and other features of the present invention will become readily apparent upon further review of the following specification and drawings.

### BRIEF DESCRIPTION OF THE DRAWING

FIG. 1 is a schematic diagram of a method and apparatus for improved gas turbine efficiency and augmented power output according to the present invention. The benefits of the present invention will become apparent to those skilled in the art from the following detailed description, wherein a preferred embodiment of the invention is shown as described, simply by way of illustration of the best mode contemplated of carrying out the invention.

### DETAILED DESCRIPTION OF THE PREFERRED EMBODIMENT

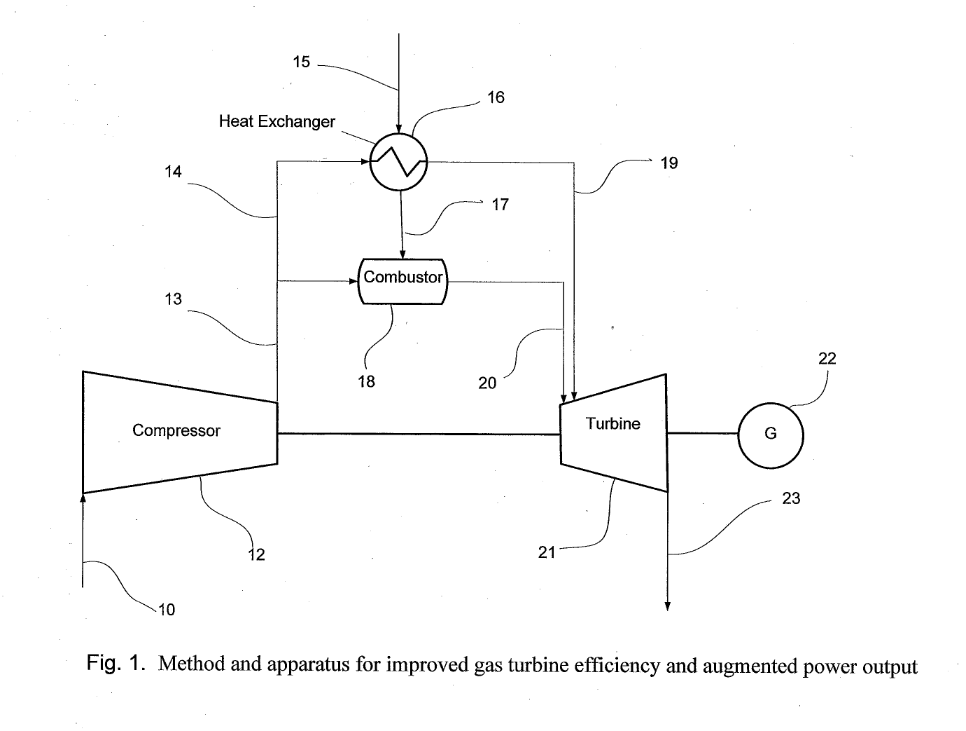

The present invention a method and apparatus for improved gas turbine efficiency and augmented power output. Referring to FIG. 1, an illustrated embodiment of a method and apparatus for improved gas turbine efficiency and augmented power output employs a gas turbine, which usually consists of an axial air compressor 12, combustor 18, power turbine 21 and electric generator or another mechanical rotating device 22. Hot flue gas 20 exiting the combustor enters the power turbine 21, which drives both the compressor 12 and generator (or another rotating mechanical device) 22. Exhaust gas 23 in a simple gas turbine cycle is discharges to the atmosphere via a stack, or enters a heat recovery steam generator (HRSG) in a combined gas turbine cycle, not shown on the drawing.

Ambient air 10 is drawn into the compressor 12, where it is compressed prior to entering the combustor 18. In a typical configuration part of the compressor discharge air 14 is used for cooling of hot power turbine components, such as turbine vanes and blades. Modern gas turbines usually operate at compression ratios of 10 to 20. Higher compression ratio corresponds to higher turbine efficiency. With high compression ratios compressor discharge air has the required pressure to cool the components, however, increasing the compression ratio in turn increases the compressor discharge air temperature, which lowers the cooling potential of the cooling air 14. Air temperatures corresponding to such compression ratios in modern gas turbines are in the 650-950 deg. F. range. At such high temperature in many cases the cooling air has to be cooled itself before entering the gas turbine component cooling system. Various external coolers may be used for this purpose utilizing ambient air, water, etc. Most of those external coolers directly contribute to the thermal cycle heat losses and lower efficiency.

For better component cooling it is desirable to lower the cooling air 14 temperature. For energy efficiency improvement it is desirable to capture and reuse the heat of this air flow as well as pre-heat incoming fuel gas prior to entering the combustor 18. The subject of this invention is a gas turbine system with additional air to fuel heat exchanger 16 which allows capturing heat of the hot cooling air and simultaneously pre-heat incoming to the combustion chamber fuel gas. Thus the energy efficiency of gas turbine is improved, and cooling potential of component cooling air is increased. Better component cooling would allow increasing gas turbine combustion temperature, which in turn further improves gas turbine efficiency and augments power output.

According to the current invention fuel flow 15 is introduced to the combustor 18 via the air-to-fuel heat exchanger 16. Heated fuel 17 exiting the heat exchanger 16 enters the combustor 18, where the chemical reaction of combustion takes place. Hot component cooling air 14 enters the heat exchanger 16, where the colder fuel 15 cools it. Exiting from the heat exchanger cooling air 19 at reduced temperature enters the gas turbine component cooling system.

I claim:

1. A combustion turbine power generation system comprising of air compressor, combustor, power turbine and air-to-fuel heat exchanger, having a gas turbine driving an electric generator or another rotating device, the gas turbine having an air intake and exhaust outlet, fuel inlet to an air-to-fuel heat exchanger, heated fuel outlet from the heat exchanger to the combustor of the gas turbine; hot turbine component cooling air inlet to the air-to-fuel heat exchanger, chilled turbine component cooling air outlet from the heat exchanger to the turbine component cooling system;

2. A combustion turbine power generation system according to claim 1, wherein the air-to-gas heat exchanger is a shell and tube type, plate type or any other surface type heat exchanger;

3. A combustion turbine power generation system according to claim 1, which uses gaseous or liquid fuel.

4. A method for producing electrical power comprising the steps of employing a gas turbine, the gas turbine having an air intake and exhaust gas from the gas turbine to the stack or heat recovery steam generator (HRSG) and an air-to-gas heat exchanger to cool down cooling air of hot components of the gas turbine and simultaneously pre-heat gas turbine incoming fuel stream;

5. A method for producing mechanical power comprising the steps of employing a gas turbine, the gas turbine having an air intake and exhaust gas from the gas turbine to the stack or heat recovery steam generator (HRSG) and an air-to-gas heat exchanger to cool down cooling air of hot components of the gas turbine and simultaneously pre-heat gas turbine incoming fuel stream;

6. A method for improving gas turbine efficiency in a simple power generation cycle (Brayton cycle) or combined power generation cycle by pre-heating fuel with hot compressor discharge air utilized for cooling of hot turbine components cooling.

7. A method for augmenting power output and improving gas turbine efficiency in a simple power generation cycle (Brayton cycle) or combined power generation cycle, by cooling hot compressor discharge air utilized for hot turbine components cooling, and therefore allowing higher combustion temperatures.

8. A method for producing electrical power according to claims 4 and 5 wherein said gas turbine configured in a combined cycle gas turbine power generation system, wherein said combined cycle includes a heat recovery steam generator (HRSG), a steam turbine driven by steam generated in the HRSG and a second generator driven by the steam turbine.

9. A method for producing mechanical power according to claims 4 and 5 wherein said gas turbine configured in a combined cycle gas turbine power generation system, wherein said combined cycle includes a heat recovery steam generator (HRSG), a steam turbine driven by steam generated in the HRSG and a second generator driven by the steam turbine.
